(19) United States
(12) Patent Application Publication
(10) Pub. No.: US 2025/0218639 A1
(43) Pub. Date: Jul. 3, 2025

(54) MULTILAYER COIL COMPONENT

(71) Applicant: Murata Manufacturing Co., Ltd., Kyoto-fu (JP)

(72) Inventors: Natnicha SIRIMONGKOL, Nagaokakyo-shi (JP); Yuudai SUZUKI, Nagaokakyo-shi (JP)

(73) Assignee: Murata Manufacturing Co., Ltd., Kyoto-fu (JP)

(21) Appl. No.: 19/002,170

(22) Filed: Dec. 26, 2024

(30) Foreign Application Priority Data
Dec. 28, 2023 (JP) 2023-222451
Sep. 25, 2024 (JP) 2024-166221

(51) Int. Cl. H01F 17/00; H01F 27/29; H01F 27/32

(52) U.S. Cl. CPC H01F 17/0013; H01F 27/292; H01F 27/324; H01F 2017/002

(57) ABSTRACT

A multilayer coil component includes a multilayer body formed by laminating insulating layers and having a coil therein; and a first outer electrode and a second outer electrode electrically connected to the coil. The coil is formed by electrically connecting a plurality of coil conductors laminated together with the insulating layers. The number of the coil conductors is greater than or equal to three. In a cross-section perpendicular to a direction in which the coil conductors extend, a cross-sectional shape of the coil conductors is a flat shape. The coil conductor closest to a center of the multilayer body in a lamination direction is a first coil conductor. A cavity is between one surface of at least one of the coil conductors, except the first coil conductor, and the insulating layer. No cavity is between an outer end portion of the first coil conductor and the insulating layer.

### CROSS-REFERENCE TO RELATED APPLICATIONS

This application claims benefit of priority to Japanese Patent Application No. 2024-166221, filed Sep. 25, 2024, and to Japanese Patent Application No. 2023-222451, filed Dec. 28, 2023, the entire content of each are incorporated herein by reference.

### BACKGROUND

### Technical Field

The present disclosure relates to a multilayer coil component.

### Background Art

Japanese Unexamined Patent Application Publication No. 11-219821 describes a multilayer inductor that is produced by firing a multilayer body formed by laminating a conductive paste and a magnetic paste made by mixing magnetic powder with a binder. The multilayer inductor is characterized by having a cavity portion between a conductor layer forming an internal coil and a magnetic layer.

### SUMMARY

For the multilayer inductor described in Japanese Unexamined Patent Application Publication No. 11-219821, a technique is disclosed in which, as illustrated in FIG. 3 in Japanese Unexamined Patent Application Publication No. 11-219821, a cavity portion is provided around the entire circumference of a circumferential coil.

By providing a cavity as described above to cut the binding at the interface between a coil conductor and an insulating layer therearound, residual stress caused by a difference in shrinkage between a coil conductor material and an insulating layer material during firing (typically, a coil conductor material has a greater shrinkage rate than an insulating layer material) can be reduced. Therefore, it is possible to reduce a decrease in magnetic permeability of the multilayer body caused by residual stress and a degradation in Z characteristics (electrical characteristics) of the inductor, and thus is possible to improve the Z characteristics of the inductor.

However, when a cavity is formed around the entire circumference of the coil conductor as in the multilayer inductor described in Japanese Unexamined Patent Application Publication No. 11-219821, the proportion of cavities in the multilayer body (element body) is too large and the strength of the multilayer body decreases as a result. External stress tends to concentrate particularly on the cavity at the outer end portion of the coil conductor, and cracks may develop around the cavity. Additionally, bending stress and external force from a mounter nozzle or the like largely concentrate near the center of the multilayer body and cracks may develop in this area.

Therefore, the present disclosure provides a multilayer coil component that can relieve residual stress generated between a coil conductor and an insulating layer therearound while maintaining the strength of a multilayer body.

A multilayer coil component according to a first aspect of the present disclosure includes a multilayer body formed by laminating a plurality of insulating layers, the multilayer body having a coil therein; and a first outer electrode and a second outer electrode electrically connected to the coil. The coil is formed by electrically connecting a plurality of coil conductors laminated together with the insulating layers. The number of the coil conductors is greater than or equal to three. In a cross-section perpendicular to a direction in which the coil conductors extend, a cross-sectional shape of the coil conductors is a flat shape. The coil conductor closest to a center of the multilayer body in a lamination direction is a first coil conductor. A cavity is provided between one surface of at least one of the coil conductors, except the first coil conductor, and the insulating layer. No cavity is provided between an outer end portion of the first coil conductor and the insulating layer.

A multilayer coil component according to a second aspect of the present disclosure includes a multilayer body formed by laminating a plurality of insulating layers, the multilayer body having a coil therein; and a first outer electrode and a second outer electrode electrically connected to the coil. The coil is formed by electrically connecting a plurality of coil conductors laminated together with the insulating layers. A cavity is provided between at least one of the coil conductors and the insulating layer to be biased toward an inner side of the coil conductor.

The present disclosure can provide a multilayer coil component that can relieve residual stress generated between a coil conductor and an insulating layer therearound while maintaining the strength of a multilayer body.

### BRIEF DESCRIPTION OF THE DRAWINGS

FIG. 1 is a perspective view schematically illustrating an example of a multilayer coil component according to Embodiment 1;

FIG. 2 is an exploded perspective view schematically illustrating an example of a multilayer body constituting the multilayer coil component illustrated in FIG. 1;

FIG. 3 is a transparent side view schematically illustrating an example of an internal structure of the multilayer body constituting the multilayer coil component illustrated in FIG. 1;

FIG. 4 is a cross-sectional view schematically illustrating an example of a cross-section taken along line segment A1-A1 in the multilayer coil component illustrated in FIG. 1;

FIG. 5 is a cross-sectional view schematically illustrating another example (Modification 1) of the cross-section taken along line segment A1-A1 in the multilayer coil component illustrated in FIG. 1;

FIG. 6 is a cross-sectional view schematically illustrating still another example (Modification 2) of the cross-section taken along line segment A1-A1 in the multilayer coil component illustrated in FIG. 1;

FIG. 7 is an exploded perspective view schematically illustrating another example (Modification 3) of the multilayer body constituting the multilayer coil component illustrated in FIG. 1;

FIG. 8 is a transparent side view schematically illustrating an example of an internal structure of another example (Modification 3) of the multilayer body constituting the multilayer coil component illustrated in FIG. 1;

FIG. 9 is a cross-sectional view schematically illustrating another example (Modification 3) of the cross-section taken along line segment A1-A1 in the multilayer coil component illustrated in FIG. 1;

FIG. 10 is a transparent view schematically illustrating an example of an internal structure of the multilayer body constituting the multilayer coil component illustrated in FIG. 1, as viewed from a second end surface of the multilayer body;

FIG. 11 schematically illustrates models of Examples 1 and 2 and Comparative Examples 1 and 2 used in stress simulation;

FIG. 12 illustrates results of stress analysis on models of Examples 1 and 2 and Comparative Examples 1 and 2;

FIG. 13 is a graph showing stress values of Examples 1 and 2 and Comparative Examples 1 and 2;

FIG. 14 schematically illustrates models of Examples 3 and 4 and Comparative Examples 3 and 4 used in stress simulation;

FIG. 15 illustrates results of stress analysis on models of Examples 3 and 4 and Comparative Examples 3 and 4;

FIG. 16 is a graph showing stress values of Examples 3 and 4 and Comparative Examples 3 and 4;

FIG. 17 schematically illustrates a test method for verifying the amount of side gap;

FIG. 18 is a cross-sectional view schematically illustrating an example of a multilayer coil component according to Embodiment 2;

FIG. 19 is a cross-sectional view schematically illustrating another example of the multilayer coil component according to Embodiment 2, illustrating a coil conductor and its vicinity;

FIG. 20 schematically illustrates models of Example 5 and Comparative Examples 5 and 6 used in stress simulation;

FIG. 21 illustrates results of stress analysis on models of Example 5 and Comparative Examples 5 and 6; and

FIG. 22 is a graph showing stress values of Example 5 and Comparative Examples 5 and 6.

### DETAILED DESCRIPTION

A multilayer coil component according to the present disclosure will now be described. Note that the present disclosure is not limited to configurations described below, and may be changed as appropriate without departing from the gist of the present disclosure. The present disclosure also includes combinations of preferred configurations described below.

The drawings to be described below are schematic illustrations, and dimensions, scales of aspect ratios, and the like may differ from those of actual products. In the drawings, the same reference numerals are used for the same or equivalent parts. The same elements in the drawings are given the same reference numerals to omit redundant descriptions.

In the present specification, the terms indicating relations between elements (e.g., “parallel”, “orthogonal”, etc.) and the terms indicating shapes of elements are used not only in their literal, strict senses, but also in substantially the same senses, such as those including differences on the order of several percent.

Embodiments described below are examples and configurations described in different embodiments may be partially replaced or combined. In the second embodiments and other embodiments that follow, the description of matters that are common to the first embodiment will be omitted and differences alone will be described. In particular, the same operations and effects achieved by the same configurations will not be mentioned for every embodiment.

### Embodiment 1

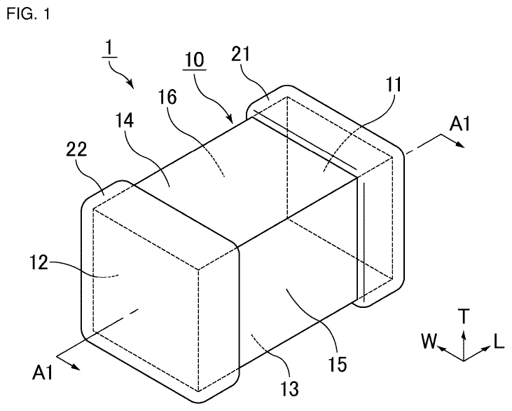

FIG. 1 is a perspective view schematically illustrating an example of a multilayer coil component according to Embodiment 1.

A multilayer coil component 1 illustrated in FIG. 1 includes a multilayer body (element body) 10, and a first outer electrode 21 and a second outer electrode 22 disposed on an outer surface of the multilayer body 10. The multilayer body 10 is in the shape of a rectangular parallelepiped having six surfaces. As will be described below, the multilayer body 10 is configured by laminating a plurality of insulating layers and a plurality of coil conductors in a lamination direction and has a coil therein. The first outer electrode 21 and the second outer electrode 22 are individually electrically connected to the coil.

In the multilayer coil component and the multilayer body in the present specification, a length direction, a height direction, and a width direction are an L direction, a T direction, and a W direction, respectively, in FIG. 1. The length direction L, the height direction T, and the width direction W are orthogonal to each other. Here, the length direction L is a direction parallel to the lamination direction.

As illustrated in FIG. 1, the multilayer body 10 has a first end surface 11 and a second end surface 12 facing each other in the length direction L, a first principal surface 13 and a second principal surface 14 facing each other in the height direction T orthogonal to the length direction L, and a first side surface 15 and a second side surface 16 facing each other in the width direction W orthogonal to the length direction L and the height direction T.

Although not illustrated in FIG. 1, the multilayer body 10 is preferably rounded at corners and ridges thereof. A corner is a portion where three surfaces of the multilayer body meet, and a ridge is a portion where two surfaces of the multilayer body meet.

The first outer electrode 21 covers, for example as illustrated in FIG. 1, the entire first end surface 11 of the multilayer body 10 and extends from the first end surface 11 to cover part of the first principal surface 13, part of the second principal surface 14, part of the first side surface 15, and part of the second side surface 16.

The second outer electrode 22 covers, for example as illustrated in FIG. 1, the entire second end surface 12 of the multilayer body 10 and extends from the second end surface 12 to cover part of the first principal surface 13, part of the second principal surface 14, part of the first side surface 15, and part of the second side surface 16.

When the multilayer coil component 1, including the first outer electrode 21 and the second outer electrode 22 arranged as described above, is to be mounted on a substrate, one of the first principal surface 13, the second principal surface 14, the first side surface 15, and the second side surface 16 of the multilayer body 10 serves as a mounting surface.

The first outer electrode 21 is simply required to extend from at least part of the first end surface 11 of the multilayer body 10 to the mounting surface of the multilayer body 10.

Similarly, the second outer electrode 22 is simply required to extend from at least part of the second end surface 12 of the multilayer body 10 to the mounting surface of the multilayer body 10.

The first outer electrode 21 and the second outer electrode 22 may each have either a single-layered structure or a multi-layered structure.

When the first outer electrode 21 and the second outer electrode 22 each have a single-layered structure, the constituent material of the outer electrode is, for example, Ag, Au, Cu, Pd, Ni, Al, or an alloy containing at least one of these metals.

When the first outer electrode 21 and the second outer electrode 22 each have a multi-layered structure, the outer electrode may include, for example, a base electrode layer containing Ag, a Ni coating, and a Sn coating in order from the surface side of the multilayer body 10.

The size of the multilayer coil component according to the present disclosure is not particularly limited, but it is preferably size 1608, size 0603, size 0402, or size 1005.

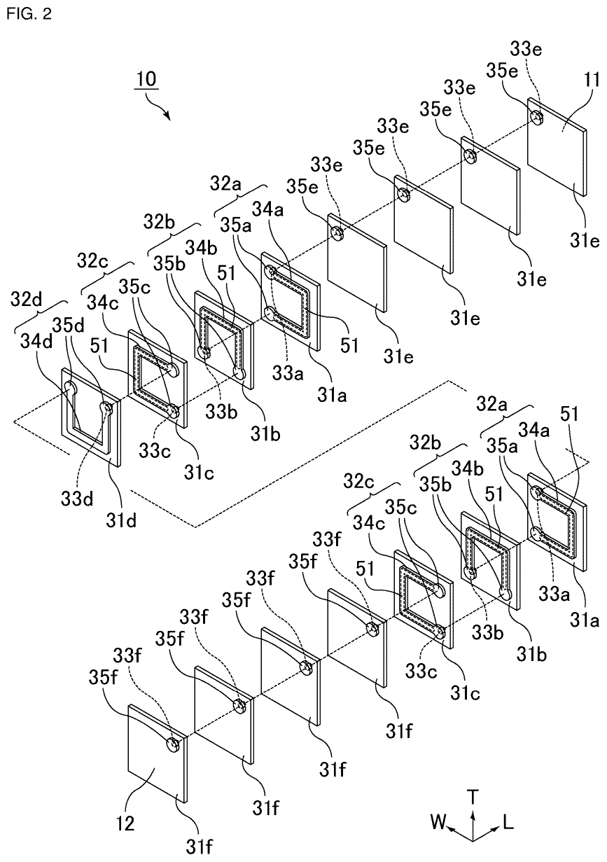

FIG. 2 is an exploded perspective view schematically illustrating an example of a multilayer body constituting the multilayer coil component illustrated in FIG. 1.

As illustrated in FIG. 2, the multilayer body 10 is configured by laminating a plurality of insulating layers 31a, 31b, 31c, 31d, 31e, and 31f from the first end surface 11 toward the second end surface 12 of the multilayer body 10 in the lamination direction (or the length direction L here). Hereinafter, the insulating layers 31a, 31b, 31c, 31d, 31e, and 31f may be collectively referred to as insulating layers 31.

In the present specification, a direction in which the plurality of insulating layers constituting the multilayer body are laminated is referred to as a lamination direction.

In FIG. 2, the insulating layers 31e are arranged on the lower side in the lamination direction (or on the side of the first end surface 11 of the multilayer body 10), and the insulating layers 31f are arranged on the upper side in the lamination direction (or on the side of the second end surface 12 of the multilayer body 10).

The constituent material of each insulating layer 31 is, for example, a magnetic material, such as a ferrite material.

The insulating layers 31a, 31b, 31c, and 31d are provided with coil conductors 32a, 32b, 32c, and 32d, respectively, and via conductors 33a, 33b, 33c, and 33d, respectively. The insulating layers 31e are each provided with a via conductor 33e and a land 35e. The insulating layers 31f are each provided with a via conductor 33f and a land 35f. There may be one insulating layer 31e, or may be two or more insulating layers 31e. Similarly, there may be one insulating layer 31f, or may be two or more insulating layers 31f. Hereinafter, the coil conductors 32a, 32b, 32c, and 32d may be collectively referred to as coil conductors 32.

The coil conductors 32a, 32b, 32c, and 32d are disposed on respective principal surfaces of the insulating layers 31a, 31b, 31c, and 31d and laminated together with the insulating layers 31a, 31b, 31c, 31d, 31e, and 31f. In FIG. 2, the coil conductors 32 each have a ¾ turn shape and are repeatedly laminated, with four insulating layers 31 arranged in the order of insulating layers 31a, 31b, 31c, and 31d as one unit (three turns).

The coil conductors 32a, 32b, 32c, and 32d include annular circumferential portions 34a, 34b, 34c, and 34d, respectively, each being partially missing and leaving a gap, and lands 35a, 35b, 35c, and 35d, respectively. The circumferential portions 34a, 34b, 34c, and 34d are provided with the lands 35a, 35b, 35c, and 35d, respectively, at both end portions thereof. Hereinafter, the circumferential portions 34a, 34b, 34c, and 34d may be collectively referred to as circumferential portions 34.

The via conductors 33a, 33b, 33c, 33d, 33e, and 33f are provided so as to pass through the insulating layers 31a, 31b, 31c, 31d, 31e, and 31f, respectively, in the lamination direction. Hereinafter, the via conductors 33a, 33b, 33c, 33d, 33e, and 33f may be collectively referred to as via conductors 33.

The lands 35e and 35f are disposed directly on the via conductors 33e and 33f, respectively. The lands 35a, 35b, 35c, 35d, 35e, and 35f are preferably slightly greater than the line width of the circumferential portions 34a, 34b, 34c, and 34d. Hereinafter, the lands 35a, 35b, 35c, 35d, 35e, and 35f may be collectively referred to as lands 35. The lands 35 are greater than the via conductors 33 adjacent thereto. When viewed in the lamination direction (length direction L), the via conductor 33 adjacent to each land 35 is within the region of the land 35.

The constituent material of the coil conductors 32, each including the circumferential portion 34 and the lands 35, and the via conductors 33 is, for example, Ag, Au, Cu, Pd, Ni, Al, or an alloy containing at least one of these metals.

The plurality of insulating layers 31a, 31b, 31c, 31d, 31e, and 31f configured as described above are laminated in the lamination direction. The multilayer body 10 is thus produced, and the plurality of coil conductors 32a, 32b, 32c, and 32d are electrically connected, with the via conductors 33a, 33b, 33c, and 33d therebetween. This produces, in the multilayer body 10, a solenoid coil having a coil axis parallel to the lamination direction.

The via conductors 33e and the lands 35e form a first extended conductor inside the multilayer body 10 and are exposed to the first end surface 11 of the multilayer body 10. That is, the first extended conductor includes the via conductors 33e and the lands 35e. As described below, in the multilayer body 10, the first extended conductor connects the first outer electrode 21 to the coil conductor 32a facing the first outer electrode 21.

The via conductors 33f and the lands 35f form a second extended conductor inside the multilayer body 10 and are exposed to the second end surface 12 of the multilayer body 10. That is, the second extended conductor includes the via conductors 33f and the lands 35f. As described below, in the multilayer body 10, the second extended conductor connects the second outer electrode 22 to the coil conductor 32d facing the second outer electrode 22.

The coil conductors 32 preferably overlap each other when viewed in the lamination direction (length direction L). When viewed in the lamination direction, the coil may have a shape composed of straight portions, such as those illustrated in FIG. 2 (e.g., a polygonal shape, such as a rectangular shape), a shape composed of curved portions (e.g., a circular shape), or a shape composed of straight and curved portions.

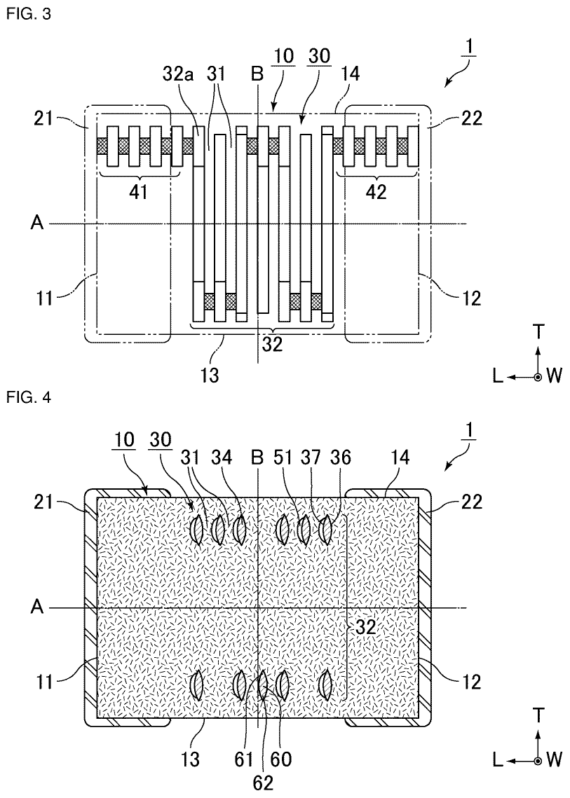

FIG. 3 is a transparent side view schematically illustrating an example of an internal structure of the multilayer body constituting the multilayer coil component illustrated in FIG. 1.

As illustrated in FIG. 3, in the multilayer coil component 1, where the plurality of insulating layers 31 are laminated in the length direction L, the length direction L is the lamination direction. The lamination direction of the multilayer body 10 and a coil axis A of a coil 30 are parallel to one of the first principal surface 13, the second principal surface 14, the first side surface 15, and the second side surface 16, serving as the mounting surface. For example, the lamination direction and the coil axis A are parallel to the first principal surface 13. That is, the multilayer coil component 1 is a horizontally-wound multilayer inductor in which the coil 30 is disposed, with the coil axis A parallel to the mounting surface.

As illustrated in FIG. 3, actually, no boundaries are visually recognized between adjacent insulating layers 31.

A first extended conductor 41 extends in the lamination direction inside the multilayer body 10 and linearly connects the first outer electrode 21 on the first end surface 11 to the coil conductor 32a facing the first outer electrode 21. Similarly, a second extended conductor 42 extends in the lamination direction inside the multilayer body 10 and linearly connects the second outer electrode 22 on the second end surface 12 to the coil conductor 32d facing the second outer electrode 22.

When viewed in the lamination direction (length direction L), the via conductors constituting each extended conductor preferably overlap each other. However, the via conductors constituting each extended conductor are not necessarily required to be arranged exactly in a straight line.

FIG. 2 and FIG. 3 illustrate an example in which the number of coil conductors 32 laminated to form three turns of the coil 30 is four; that is, the repeating shape of the coil conductors 32 is a ¾ turn shape. However, the number of coil conductors 32 laminated to form one turn of the coil 30 is not particularly limited. For example, the number of coil conductors 32 laminated to form one turn of the coil 30 may be two; that is, the repeating shape may be a ½ turn shape.

The number of coil conductors 32 laminated, that is, the number of all the coil conductors 32 laminated in the multilayer body 10, may be any number greater than or equal to 3, but it is preferably greater than or equal to 10 and less than or equal to 60 (i.e., from 10 to 60). As illustrated in FIG. 2 to FIG. 4, the number of coil conductors 32 laminated may be an odd number greater than or equal to three.

FIG. 4 is a cross-sectional view schematically illustrating an example of a cross-section taken along line segment A1-A1 in the multilayer coil component illustrated in FIG. 1. Note that FIG. 4 illustrates a cross-section of the circumferential portions 34 of the coil conductors 32.

As illustrated in FIG. 4, in a cross-section perpendicular to the direction in which the coil conductors 32 extend, the cross-sectional shape of the coil conductors 32 is a flat shape (longitudinal shape) and its longitudinal direction is orthogonal to the lamination direction (length direction L). In the example illustrated in FIG. 4, the cross-sectional shape of the coil conductors 32 is an elliptical shape whose major axis is orthogonal to the lamination direction. However, the cross-sectional shape of the coil conductors 32 is not particularly limited and may be, for example, a rectangular shape whose sides forming a pair and opposite each other in the lamination direction have the same length, or a trapezoidal shape whose sides forming a pair and opposite each other in the lamination direction have different lengths.

As illustrated in FIG. 4, the coil conductors 32 each have a first surface 36 facing in a first direction parallel to the coil axis A and a second surface 37 facing in a direction opposite the first direction. The first surface 36 and the second surface 37 both extend in a direction orthogonal to the lamination direction.

Here, the coil conductor 32 closest to the center (see a center line B in FIG. 3 and FIG. 4) of the multilayer body 10 in the lamination direction (length direction L) is defined as a first coil conductor 60 (see FIG. 4).

A cavity 51 is provided between one surface of at least one of the coil conductors 32, except the first coil conductor 60, and the insulating layer 31, and no cavity is provided between the outer end portion 62 of the first coil conductor 60 and the insulating layer 31. For the coil conductor 32 in the center of the multilayer body 10, no cavity is provided adjacent to at least the outer end portion 62, whereas for the other coil conductors 32, a cavity is provided adjacent to one surface of each coil conductor 32. This can relieve residual stress generated between the coil conductor 32 and the insulating layer therearound while maintaining the strength of the multilayer body 10. Hereinafter, when the cavity 51 is provided between one surface of the coil conductor 32 and the insulating layer 31, it may be simply referred to as “a cavity is provided on one surface of the coil conductor 32”.

In the present specification, the term “cavity” refers to a space where the coil and the insulating layer are not in contact (i.e., a space between the coil and the insulating layer) and whose thickness is greater than or equal to 1.5 μm. Therefore, if the thickness of the space where the coil and the insulating layer are not in contact is less than 1.5 μm, the space is not treated as a cavity. For example, air bubbles with a thickness of less than 1.5 μm are not treated as cavities even when they are present between the coil and the insulating layer.

When a cavity is formed around the entire circumference of every coil conductor as in the multilayer inductor described in Japanese Unexamined Patent Application Publication No. 11-219821, or when a cavity is formed only on one surface of every coil conductor, since there will be a cavity near the center of the multilayer body at which external stress tends to concentrate during mounting of the multilayer coil component, external stress tends to concentrate on the cavity portion. For example, when bending stress is applied as external stress, the bending stress tends to be applied to the center of the multilayer body in the lamination direction, particularly to the outer end portion of the coil conductor in the center of the multilayer body in the lamination direction. Bending stress also tends to be applied particularly during manufacture and transport of the multilayer coil component. There have been instances where bending stress has caused cracks to start from the cavity at the outer end portion of the coil conductor in the center of the multilayer body in the lamination direction. In the present embodiment, on the other hand, no cavity is provided at the outer end portion 62 of the first coil conductor 60 closest to the center of the multilayer body 10 in the lamination direction. This can relieve such external stress and thus can maintain the strength of the multilayer body 10.

It is also possible to enhance strength against stress applied to the multilayer body by the mounter nozzle during mounting, although this is a problem specific to horizontally-wound multilayer inductors. Specifically, since the mounter nozzle applies pressure to the center portion, in the lamination direction, of the outer surface facing the mounting surface of the multilayer body, stress is applied to the multilayer body, originating from the center portion described above. In the multilayer coil component 1, which is a horizontally-wound multilayer inductor, strength against cracks caused by such stress can also be enhanced.

The multilayer body, except the center portion thereof in the lamination direction, is less likely to be subjected to concentration of external stress, such as that described above. Therefore, the cavity 51 is provided for every coil conductor 32 except the first coil conductor 60, that is, for every coil conductor 32 away from the center of the multilayer body 10 in the lamination direction. This can relieve residual stress caused by a difference in shrinkage between the coil conductor material and the insulating layer material during firing. Since the cavity 51 is provided only on one surface of each coil conductor 32, it is possible to prevent a decrease in the strength of the multilayer body 10 caused by a too large proportion of the cavities 51 in the multilayer body 10.

It is thus possible both to ensure the strength of the multilayer body 10 and to relieve residual stress.

In the present specification, the inner side of the coil conductor refers to one side thereof adjacent to the coil axis of the coil, and the outer side of the coil conductor refers to the other side thereof (i.e., the outer side of the coil) opposite the one side.

One surface of the coil conductor 32 provided with the cavity 51 may either be the first surface 36 or the second surface 37 of the coil conductor 32. When the cavity 51 is provided on one surface of each of the plurality of coil conductors 32 as illustrated in FIG. 4, the surface provided with the cavity 51 may either be the first surface 36 or the second surface 37. Although there may be both the coil conductors 32 each having the cavity 51 on the first surface 36 thereof and the coil conductors 32 each having the cavity 51 on the second surface 37, it is easier to manufacture when the surface provided with the cavity 51 is one of the first surface 36 and the second surface 37.

No cavity is provided between the surface of the coil conductor 32 opposite the one surface having the cavity 51 thereon and the insulating layer 31.

When there are two coil conductors 32 equidistant to the center (center line B) of the multilayer body 10 in the lamination direction, that is, when the center line B is at the center between two adjacent coil conductors 32, the two coil conductors 32 are both defined as first coil conductors 60. In this case, the cavity 51 is provided between one surface of at least one of the coil conductors 32, except the two first coil conductors 60, and the insulating layer 31, and no cavity is provided between the outer end portion 62 of each of the two first coil conductors 60 and the insulating layer 31.

As illustrated in FIG. 4, the cavity 51 may be provided between one surface of every coil conductor 32, except the first coil conductor 60, and the insulating layer 31. This can further relieve residual stress.

As illustrated in FIG. 4, no cavity may be provided between the first coil conductor 60 and the insulating layer 31. That is, the entire circumference of the first coil conductor 60 may be provided with no cavity. This can further improve the strength of the multilayer body 10.

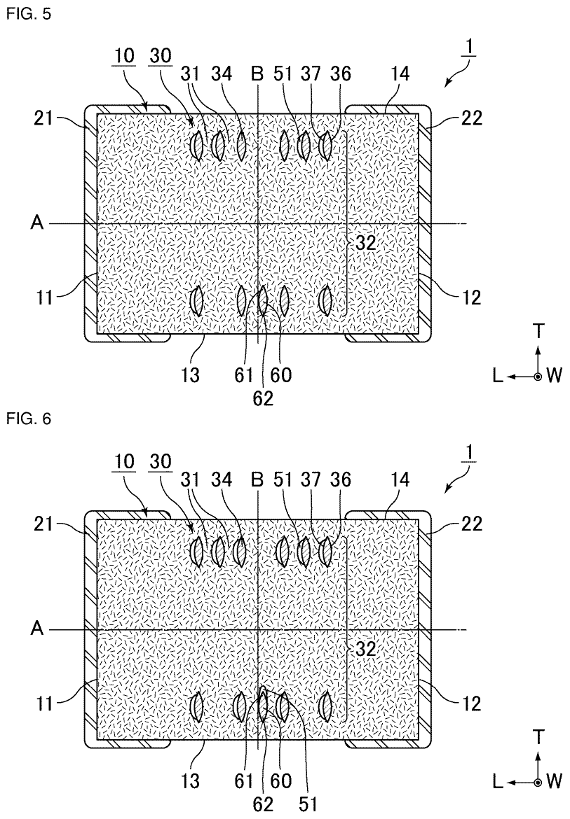

FIG. 5 is a cross-sectional view schematically illustrating another example (Modification 1) of the cross-section taken along line segment A1-A1 in the multilayer coil component illustrated in FIG. 1.

As illustrated in FIG. 5, no cavity may be provided between the insulating layer 31 and each of two coil conductors 32 immediately adjacent to the first coil conductor 60 in the lamination direction of the multilayer body 10. That is, no cavities may be provided for a total of three coil conductors 32 in the center of the multilayer body 10 in the lamination direction. This can further improve the strength of the multilayer body 10.

FIG. 6 is a cross-sectional view schematically illustrating still another example (Modification 2) of the cross-section taken along line segment A1-A1 in the multilayer coil component illustrated in FIG. 1.

As illustrated in FIG. 6, the cavity 51 may be provided between the inner end portion 61 of the first coil conductor 60 and the insulating layer 31. Since external stress tends to concentrate particularly at the outer end portion of the coil conductor, it is still possible both to ensure the strength of the multilayer body 10 and to relieve residual stress. With the cavity 51 also provided for the first coil conductor 60, residual stress can be further relieved. A cavity may be provided between the center of the first coil conductor 60 and the insulating layer 31, but no cavity may be provided between them.

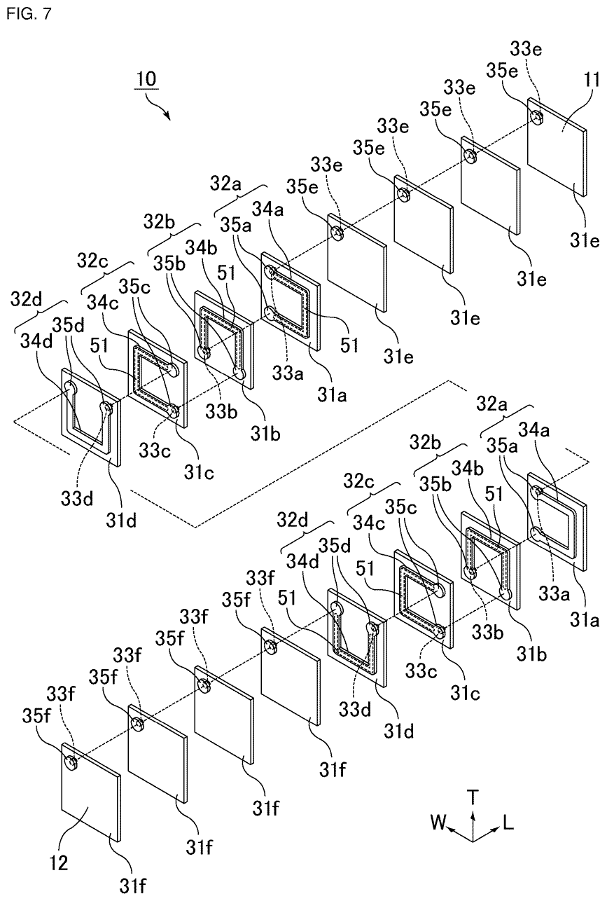

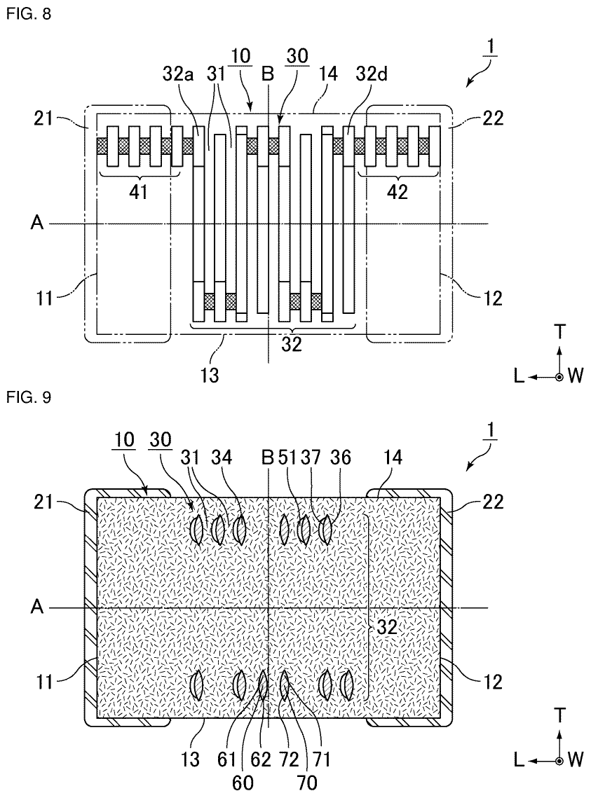

FIG. 7 is an exploded perspective view schematically illustrating another example (Modification 3) of the multilayer body constituting the multilayer coil component illustrated in FIG. 1. FIG. 8 is a transparent side view schematically illustrating an example of an internal structure of another example (Modification 3) of the multilayer body constituting the multilayer coil component illustrated in FIG. 1. FIG. 9 is a cross-sectional view schematically illustrating another example (Modification 3) of the cross-section taken along line segment A1-A1 in the multilayer coil component illustrated in FIG. 1.

As illustrated in FIG. 7 to FIG. 9, the number of coil conductors 32 laminated may be an even number greater than or equal to four. Here, the coil conductor 32 second closest to the center (see the center line B in FIG. 8 and FIG. 9) of the multilayer body 10 in the lamination direction, after the first coil conductor 60, is defined as a second coil conductor 70 (see FIG. 9). In this case, the cavity 51 may be provided between one surface of at least one of the coil conductors 32, except the first coil conductor 60 and the second coil conductor 70, and the insulating layer 31, whereas no cavity may be provided between the outer end portion 62 of the first coil conductor 60 and the insulating layer 31, and between an outer end portion 72 of the second coil conductor 70 and the insulating layer 31. This can still relieve residual stress generated between the coil conductor 32 and the insulating layer therearound while maintaining the strength of the multilayer body 10.

As illustrated in FIG. 9, the cavity 51 may be provided between one surface of every coil conductor 32, except the first coil conductor 60 and the second coil conductor 70, and the insulating layer 31. This can further relieve residual stress.

As illustrated in FIG. 9, no cavity may be provided between the first coil conductor 60 and the insulating layer 31, and between the second coil conductor 70 and the insulating layer 31. That is, the entire circumference of each of the first coil conductor 60 and the second coil conductor 70 may be provided with no cavity. This can further improve the strength of the multilayer body 10.

Although not illustrated, a cavity may be provided between the inner end portion 61 of the first coil conductor 60 and the insulating layer 31, and/or between an inner end portion 71 of the second coil conductor 70 and the insulating layer 31 (see FIG. 6). A cavity may or may not be provided between the center of the first coil conductor 60 and the insulating layer 31. Similarly, a cavity may or may not be provided between the center of the second coil conductor 70 and the insulating layer 31.

No cavity may be provided between the insulating layer 31 and each of two coil conductors 32 on both sides of the first coil conductor 60 and the second coil conductor 70 in the lamination direction of the multilayer body 10. That is, no cavities may be provided for a total of four coil conductors 32 in the center of the multilayer body 10 in the lamination direction. This can further improve the strength of the multilayer body 10.

Here, the occurrence of cracks originating from cavities, inside the element body of the multilayer coil component 1 mounted on a substrate, will be described.

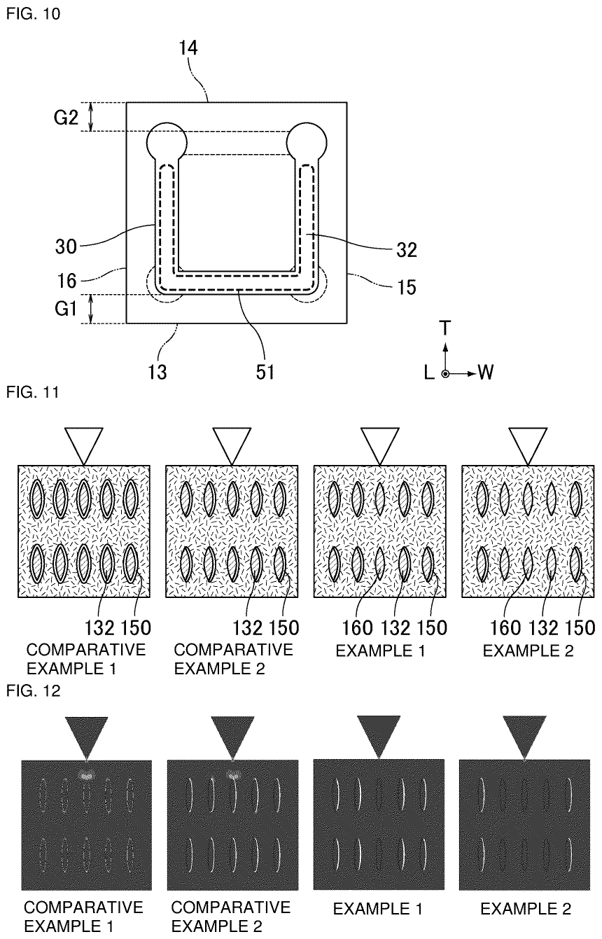

FIG. 10 is a transparent view schematically illustrating an example of an internal structure of the multilayer body constituting the multilayer coil component illustrated in FIG. 1, as viewed from the second end surface of the multilayer body.

As illustrated in FIG. 10, a space between the coil 30 and the first principal surface 13 in the height direction is defined as a side gap G1, and a space between the coil 30 and the second principal surface 14 in the height direction is defined as a side gap G2. Here, the first principal surface 13 serves as a mounting surface.

When the substrate having the multilayer coil component mounted thereon warps, stress is applied particularly to a region near an end portion of each outer electrode extending to the mounting surface, inside the element body of the multilayer coil component. When the side gap G1 decreases, the first principal surface 13 (mounting surface) and the coil conductor 32 become closer and the first principal surface 13 and the cavity 51 on the coil conductor 32 also become closer. If the side gap G1 becomes too small, the cavity 51 becomes closer to the region where stress applied is particularly high, and cracks may develop inside the element body, originating from the cavity 51.

To reduce the occurrence of cracks associated with warpage of the substrate, a certain amount of side gap G1 is to be preferably maintained. Specifically, the side gap G1 is preferably greater than or equal to 43 μm, more preferably greater than or equal to 44 μm, and still more preferably greater than or equal to 46 μm. Thus by setting the lower limit of the side gap G1, the occurrence of cracks associated with warpage of the substrate can be prevented. Although the upper limit of the side gap G1 is not particularly limited, it may be less than or equal to 150 μm. Although the side gap G2 is not particularly limited, it may be greater than or equal to 43 μm and less than or equal to 150 μm (i.e., from 43 μm to 150 μm), as in the side gap G1.

As the size of the multilayer coil component decreases, the lower limit of the side gap G1 required also decreases. Therefore, in the multilayer coil component 1 with the side gap G1 satisfying the condition described above, the occurrence of cracks associated with warpage of the substrate can be more effectively prevented. For this, the size of the multilayer coil component 1 is preferably less than or equal to size 1608 and is more preferably, for example, size 1608, size 1005, size 0603, or size 0402.

Hereinafter, results of stress simulation performed by applying external stress to the multilayer body 10 of the multilayer coil component 1 according to Embodiment 1 will be described.

FIG. 11 schematically illustrates models of Examples 1 and 2 and Comparative Examples 1 and 2 used in stress simulation.

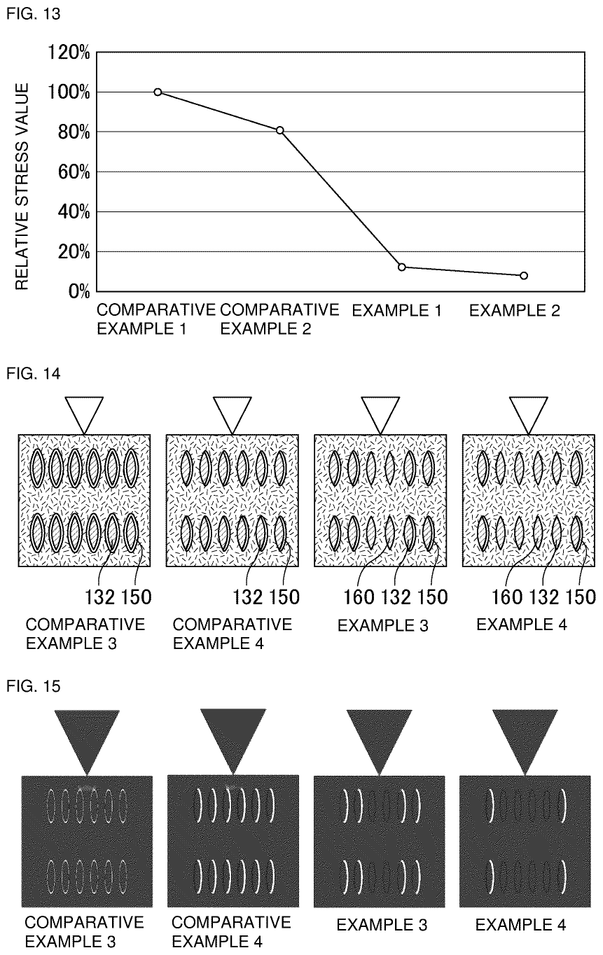

As illustrated in FIG. 11, each model includes five coil conductors 132. In the model of Example 1, a first coil conductor 160 closest to the center of the multilayer body in the lamination direction is provided with no cavity, whereas every coil conductor 132, except the first coil conductor 160, is provided with the cavity 150 on one surface thereof. In the model of Example 2, the first coil conductor 160 closest to the center of the multilayer body in the lamination direction and the coil conductors 132 on both sides of the first coil conductor 160 are provided with no cavities, whereas two outermost coil conductors 132 each are provided with the cavity 150 on one surface thereof. In the model of Comparative Example 1, every coil conductor 132 is provided with the cavity 150 around the entire surface (entire circumference) thereof. In the model of Comparative Example 2, every coil conductor 132 is provided with the cavity 150 on only one surface thereof. All the models are on the assumption that the size of the multilayer body is size 1005, the dimension in the width direction W and the dimension in the height direction T are both 0.5 mm, and the side gaps G1 and G2 are both 70 μm. The maximum thickness of the coil conductor is 20 μm, the line width of the coil conductor is 120 μm, and the cavity has a uniform thickness of 4 μm. For all the models, bending stress was applied in the same manner to a point (center of the upper surface) indicated by the apex of a triangle in FIG. 11. The results are shown in FIG. 12, FIG. 13, and Table 1 below.

FIG. 12 illustrates results of stress analysis on models of Examples 1 and 2 and Comparative Examples 1 and 2. FIG. 13 is a graph showing stress values of Examples 1 and 2 and Comparative Examples 1 and 2. Similarly, Table 1 below shows stress values of Examples 1 and 2 and Comparative Examples 1 and 2. Note that FIG. 13 and Table 1 show the value of maximum stress generated in each model, relative to the value of maximum stress generated in the model of Comparative Example 1.

TABLE 1

| Comparative | Comparative | | |
|---|---|---|---|
| Example 1 | Example 2 | Example 1 | Example 2 |
| Cavity on | Cavity on | No cavity for | No cavities for |
| entire surface | one surface | 1 coil conductor | 3 coil conductors |
| 100% | 81% | 12% | 8% |

The results show that bending stress tends to be applied to the outer end portions of the coil conductors (see Comparative Examples 1 and 2 in FIG. 12). It was found that to avoid stress from the center of the multilayer body in the lamination direction, it is effective to provide no cavity for the coil conductor in the center of the multilayer body in the lamination direction, and that this can significantly relieve stress as a result.

FIG. 14 schematically illustrates models of Examples 3 and 4 and Comparative Examples 3 and 4 used in stress simulation.

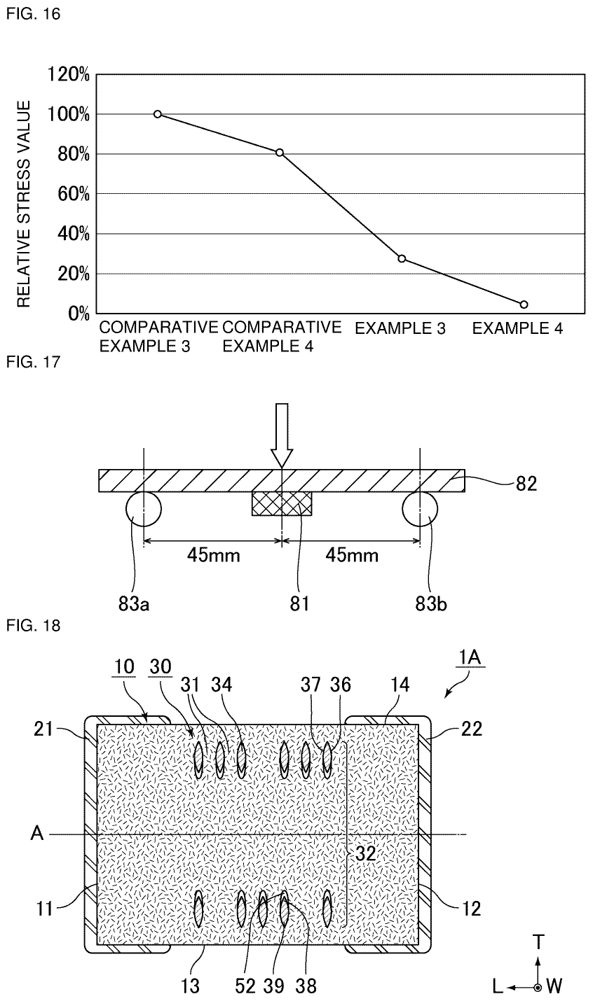

As illustrated in FIG. 14, each model includes six coil conductors 132, and there are two coil conductors equidistant to the center of the multilayer body in the lamination direction. In the model of Example 3, two first coil conductors 160 closest to the center of the multilayer body in the lamination direction are provided with no cavities, whereas every coil conductor 132, except the two first coil conductors 160, is provided with the cavity 150 on one surface thereof. In the model of Example 4, two first coil conductors 160 closest to the center of the multilayer body in the lamination direction and two coil conductors 132 on both sides of the first coil conductors 160 are provided with no cavities, whereas two outermost coil conductors 132 each are provided with the cavity 150 on one surface thereof. In the model of Comparative Example 3, every coil conductor 132 is provided with the cavity 150 around the entire surface (entire circumference) thereof. In the model of Comparative Example 4, every coil conductor 132 is provided with the cavity 150 on only one surface thereof. The other conditions are the same as those for the models illustrated in FIG. 11. For all the models, bending stress was applied in the same manner to a point (center of the upper surface) indicated by the apex of a triangle in FIG. 14. The results are shown in FIG. 15, FIG. 16, and Table 2 below.

FIG. 15 illustrates results of stress analysis on models of Examples 3 and 4 and Comparative Examples 3 and 4. FIG. 16 is a graph showing stress values of Examples 3 and 4 and Comparative Examples 3 and 4. Similarly, Table 2 below shows stress values of Examples 3 and 4 and Comparative Examples 3 and 4. Note that FIG. 16 and Table 2 show the value of maximum stress generated in each model, relative to the value of maximum stress generated in the model of Comparative Example 3.

TABLE 2

| Comparative | Comparative | | |
|---|---|---|---|
| Example 3 | Example 4 | Example 3 | Example 4 |
| Cavity on | Cavity on | No cavities for | No cavities for |
| entire surface | one surface | 2 coil conductors | 4 coil conductors |
| 100% | 81% | 28% | 5% |

The same results as those of Examples 1 and 2 and Comparative Examples 1 and 2 were obtained. That is, it was found that stress can be significantly relieved by providing no cavities for the coil conductors in the center of the multilayer body in the lamination direction.

Hereinafter, the results of verifying the amount of side gap that does not cause cracks inside the element body of the multilayer coil component, according to the present embodiment, will be described.

As samples, 15 multilayer coil components with different side gaps G1 and G2 were prepared, in which a cavity was provided only between the insulating layer and the first surface of the circumferential portion of every coil conductor. A method for manufacturing the multilayer coil component according to the present embodiment will be described below later. The present samples differ from the multilayer coil component according to the present embodiment in that the circumferential portion of the first coil conductor is also provided with a cavity over the entire one surface thereof. In the present verification, however, only the configuration near the outer electrodes of the element body is relevant. That is, the test results are not influenced even when the first coil conductor in the center of the element body is provided with a cavity. All the multilayer coil components are of size 1608. The dimensions of 15 samples were measured and the average dimensions determined were as follows: the dimensions of the multilayer coil component including the outer electrodes were 1.530 mm, 0.822 mm, and 0.822 mm in the length direction L, the width direction W, and the height direction T, respectively; and the dimensions of the multilayer body having no outer electrodes thereon were 1.372 mm, 0.783 mm, and 0.783 mm in the length direction L, the width direction W, and the height direction T, respectively.

FIG. 17 schematically illustrates a test method for verifying the amount of side gap.

As illustrated in FIG. 17, first, a multilayer coil component 81 (sample) was mounted on a substrate 82, with a first principal surface thereof as the mounting surface. The substrate 82 was supported by support portions 83a and 83b both at a distance of 45 mm from the center of the multilayer coil component 81 in the length direction, with the multilayer coil component 81 on the lower side of the substrate 82. Then, stress was applied to the center of the multilayer coil component 81 from the back side of the substrate 82 not having the multilayer coil component 81 thereon, until the amount of warpage of the substrate 82 reached 3 mm. This was followed by checking whether cracks had developed inside the element body of the multilayer coil component 81. Although 2 mm is practically sufficient as the amount of warpage, the test was performed, with the amount of warpage set to 3 mm, to allow more margin. The results are shown in Table 3 below.

TABLE 3

| Sample No. | G1 (μm) | G2 (μm) | Cracks Observed |
|---|---|---|---|
| 1 | 65.40 | 53.63 | No |
| 2 | 66.73 | 54.20 | No |
| 3 | 67.06 | 41.26 | No |
| 4 | 53.12 | 48.46 | No |
| 5 | 37.34 | 74.30 | Yes |
| 6 | 49.89 | 52.37 | No |
| 7 | 46.70 | 72.55 | No |
| 8 | 55.60 | 54.02 | No |
| 9 | 57.83 | 52.14 | No |
| 10 | 57.86 | 52.93 | No |
| 11 | 41.45 | 68.99 | Yes |
| 12 | 63.23 | 46.05 | No |
| 13 | 49.51 | 51.07 | No |
| 14 | 49.53 | 72.96 | No |
| 15 | 52.41 | 56.31 | No |

The results show that the side gap G1 is preferably greater than or equal to 43 μm, more preferably greater than or equal to 44 μm, and still more preferably greater than or equal to 46 μm.

### Embodiment 2

FIG. 18 is a cross-sectional view schematically illustrating an example of a multilayer coil component according to Embodiment 2. FIG. 18 is a drawing corresponding to the cross-sectional view FIG. 4. FIG. 18 illustrates a cross-section corresponding to the cross-section taken along line segment A1-A1 in the multilayer coil component illustrated in FIG. 1.

As illustrated FIG. 18, in a multilayer coil component 1A according to Embodiment 2, a cavity 52 is provided between at least one coil conductor 32 and the insulating layer 31 to be biased toward the inner side of the coil conductor 32. No cavities are provided on the outer side of the coil conductors 32 on which external stress tends to concentrate, and the cavities 52 are concentrated on the inner side of the coil conductors 32. This can relieve external stress and maintain the strength of the multilayer body 10. The strength of the multilayer body 10 can be greater than that in the case of the multilayer inductor described in Japanese Unexamined Patent Application Publication No. 11-219821 where every coil conductor has a cavity around the entire circumference thereof.

External stress is less likely to concentrate on the inner side of the coil conductor 32. Therefore, by providing the cavity 52 to be biased toward the inner side of the coil conductor 32, residual stress caused by a difference in shrinkage between a coil conductor material and an insulating layer material during firing can be relieved.

Thus, in the present embodiment, it is also possible both to ensure the strength of the multilayer body 10 and to relieve residual stress.

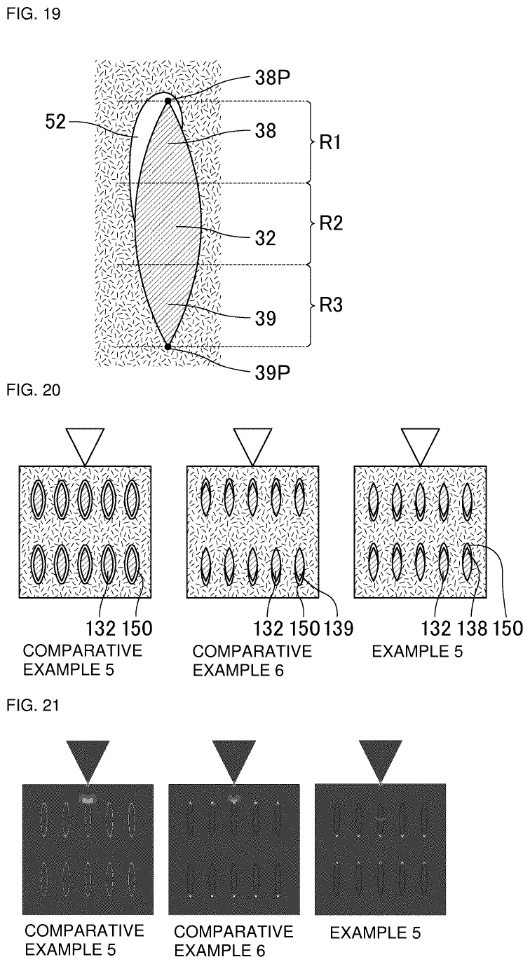

FIG. 19 is a cross-sectional view schematically illustrating another example of the multilayer coil component according to Embodiment 2, illustrating a coil conductor and its vicinity.

The cavity 52 may be provided only at an inner end portion 38 as illustrated in FIG. 18, or may be provided as illustrated in FIG. 19 to extend from an inner extremity 38P to the middle of a path to an outer extremity 39P. As illustrated in FIG. 18 and FIG. 19, it is preferable that no cavity be provided at the outer end portion 39 of the coil conductor 32.

In the present specification, an inner end portion, an outer end portion, and a center portion of the coil conductor are a region R1, a region R3, and a region R2, respectively, illustrated in FIG. 19. That is, in the cross-section (see FIG. 19) perpendicular to the direction in which the coil conductor 32 extends, when the coil conductor 32 is equally divided into three regions in the longitudinal direction (vertical direction in FIG. 19), the region R1 on the innermost side of the coil conductor 32 is referred to as an inner end portion, the region R3 on the outermost side of the coil conductor 32 is referred to as an outer end portion, and the region R2 in the center of the coil conductor 32 is referred to as a center portion.

In the present specification, when the cavity is biased toward the inner side of the coil conductor, the minimum distance from the inner extremity 38P of the coil conductor 32 to the cavity 52 is shorter than the minimum distance from the outer extremity 39P of the coil conductor 32 to the cavity 52 in the cross-section (see FIG. 19) perpendicular to the direction in which the coil conductor 32 extends. In FIG. 19, the inner extremity 38P of the coil conductor 32 is adjacent to the cavity 52, and the minimum distance from the inner extremity 38P of the coil conductor 32 to the cavity 52 is zero.

In the present specification, an inner extremity and an outer extremity of the coil conductor are the point 38P on the innermost side and the point 39P on the outermost side, respectively, of the coil conductor 32, in the cross-section (see FIG. 19) perpendicular to the direction in which the coil conductor 32 extends.

As illustrated in FIG. 18, the cavity 52 may be provided between every coil conductor 32 and the insulating layer 31 to be biased toward the inner side of the coil conductor 32.

Although not illustrated, the cavity 52 may be provided between each of only some of the coil conductors 32 and the insulating layer 31 to be biased toward the inner side of the coil conductor 32, and no cavities may be provided between the remaining coil conductors 32 and the insulating layers 31.

Hereinafter, results of stress simulation performed by applying external stress to the multilayer body 10 of the multilayer coil component 1A according to Embodiment 2 will be described.

FIG. 20 schematically illustrates models of Example 5 and Comparative Examples 5 and 6 used in stress simulation.

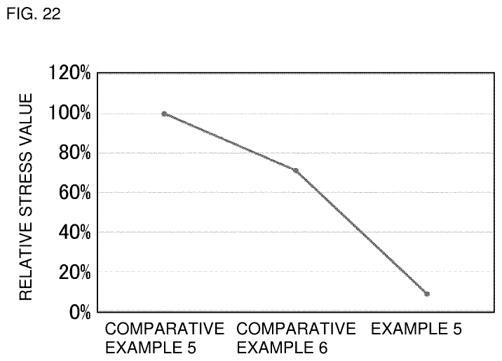

As illustrated in FIG. 20, each model includes five coil conductors 132. In the model of Example 5, only an inner end portion 138 of each coil conductor 132 is provided with the cavity 150. In the model of Comparative Example 5, every coil conductor 132 is provided with the cavity 150 around the entire surface (entire circumference) thereof. In the model of Comparative Example 6, only an outer end portion 139 of each coil conductor 132 is provided with the cavity 150. The other conditions are the same as those for the models illustrated in FIG. 11. For all the models, bending stress was applied in the same manner to a point (center of the upper surface) indicated by the apex of a triangle in FIG. 20. The results are shown in FIG. 21 and FIG. 22.

FIG. 21 illustrates results of stress analysis on models of Example 5 and Comparative Examples 5 and 6. FIG. 22 is a graph showing stress values of Example 5 and Comparative Examples 5 and 6. Note that FIG. 22 shows the value of maximum stress generated in each model, relative to the value of maximum stress generated in the model of Comparative Example 5.

The results show that bending stress tends to be applied to the outer end portions of the coil conductors in Comparative Examples 5 and 6 where there are cavities at the outer end portions of the coil conductors (see FIG. 21). It was found that to avoid the stress, it is effective to provide no cavities for the outer end portions of the coil conductors. It was also found, in Example 5 where there are cavities only at the inner end portions of the coil conductors, that inward propagation of stress applied to the outer end portions of the coil conductors can relieve stress concentration and thus can significantly relieve stress.

Although cavities provided at various points have been described in Embodiments 1 and 2, it is simply required, in the present specification, that any cavity provided between the coil conductor and the insulating layer be present in at least part of the region in the direction in which the circumferential portion of the coil conductor extends. That is, the cavity may be provided over the entire region in the direction in which the circumferential portion extends, or may be provided only in part of the region (either one or more regions) in the direction in which the circumferential portion extends.

In the multilayer coil component according to the present disclosure, there is no particular restriction on the presence or absence of a cavity between the land of the coil conductor and the insulating layer. For example, a cavity may be provided between the insulating layer and the surface of the land of each coil conductor to which no via conductor is connected. That is, even for the first coil conductor and the second coil conductor, a cavity may be provided between the insulating layer and the surface of the land to which no via conductor is connected (i.e., the surface opposite the via conductor).

Although horizontally-wound multilayer inductors have been described in Embodiments 1 and 2, the multilayer coil component according to the present disclosure may be a vertically-wound multilayer inductor including a coil, with its coil axis orthogonal to the mounting surface.

An example of a method for manufacturing the multilayer coil components according to Embodiments 1 and 2 will now be described.

### <Step of Producing Magnetic Material>

First, Fe₂O₃, ZnO, CuO, and NiO are weighed to a predetermined ratio.

Next, these weighed materials, pure water, and the like are placed in a ball mill together with partially stabilized zirconia (PSZ) media, mixed, and pulverized. The mixing and pulverizing time is, for example, longer than or equal to four hours and shorter than or equal to eight hours.

The resulting material obtained by the pulverization is dried and then calcined. The calcination temperature is, for example, higher than or equal to 700° C. and lower than or equal to 800° C. (i.e., from 700° C. to 800° C.). The calcination time is, for example, longer than or equal to two hours and shorter than or equal to five hours.

A powdered magnetic material, more specifically, a powdered magnetic ferrite material, is thus produced.

The ferrite material is preferably a Ni—Cu—Zn ferrite material.

The Ni—Cu—Zn ferrite material preferably contains, with the total amount being 100 mol %, greater than or equal to 40 mol % and less than or equal to 49.5 mol % (i.e., from 40 mol % to 49.5 mol %) of Fe in terms of Fe₂O₃, greater than or equal to 2 mol % and less than or equal to 35 mol % (i.e., from 2 mol % to 35 mol %) of Zn in terms of ZnO, greater than or equal to 6 mol % and less than or equal to 13 mol % (i.e., from 6 mol % to 13 mol %) of Cu in terms of CuO, and greater than or equal to 10 mol % and less than or equal to 45 mol % (i.e., from 10 mol % to 45 mol %) of Ni in terms of NiO.

The Ni—Cu—Zn ferrite material may further contain an additive, such as Co, Bi, Sn, or Mn.

The Ni—Cu—Zn ferrite material may further contain unavoidable impurities.

### <Step of Producing Green Sheet>

First, a magnetic material, an organic binder such as polyvinyl butyral resin, an organic solvent such as ethanol or toluene, and a plasticizer are placed in a ball mill together with PSZ media, mixed, and pulverized to produce a slurry.

After the slurry is formed into a sheet with a predetermined thickness using a doctor blade method or the like, the sheet is punched into a predetermined shape to produce a green sheet. The thickness of the green sheet is, for example, greater than or equal to 20 μm and less than or equal to 30 μm (i.e., from 20 μm to 30 μm). The shape of the green sheet is, for example, rectangular.

As the material of the green sheet, a non-magnetic material, such as a borosilicate glass material, may be used instead of the magnetic material, or a mixture of the magnetic material and the non-magnetic material may be used.

### <Step of Forming Conductor Pattern>

First, via holes are formed by irradiating a predetermined area of the green sheet with a laser.

After a resin paste is applied to the surface of the green sheet by screen printing or the like, a conductive paste, such as an Ag paste, is applied to the surface of the green sheet by screen printing or the like while the via holes are being filled with the conductive paste. The resin paste is obtained by adding, to a solvent (such as isophorone), a resin (such as acryl resin) to be burned out during firing. The resin paste is applied to an area where cavities are to be formed. Thus, while a via conductor pattern is being formed in the via holes in the green sheet, a coil conductor pattern connected to the via conductor pattern is formed on the surface of the green sheet, with a cavity-forming resin pattern therebetween. Then, a resin paste may be applied onto the coil conductor pattern to further form a cavity-forming resin pattern. A coil sheet is thus produced by forming the coil conductor pattern, the via conductor pattern, and the cavity-forming resin pattern on the green sheet. A coil conductor pattern corresponding to the coil conductors 32 illustrated in FIG. 2 and a via conductor pattern corresponding to the via conductors 33 illustrated in FIG. 2 (excluding the via conductors 33e and 33f) are formed on the coil sheet. The cavity-forming resin pattern may be substantially the same as the coil conductor pattern. In this case, the cavity-forming resin pattern may have a line width slightly smaller than the line width of the coil conductor pattern.

No resin paste may be applied to an area where cavities for land portions are to be formed. This is because even in this case, there is much conductive paste in this area and shrinkage of the conductive paste can form cavities adjacent to lands.

Separately from the coil sheet, a via sheet having thereon a via conductor pattern corresponding to the via conductors 33e and 33f illustrated in FIG. 2 and a land conductor pattern corresponding to the lands 35e and 35f illustrated in FIG. 2, is produced.

### <Step of Producing Multilayer Body Block>

A multilayer body block is produced by laminating the coil sheet and the via sheet in the lamination direction (length direction L) in the order corresponding to FIG. 2 and applying thermocompression bonding to the resulting laminate.

### <Step of Producing Multilayer Body and Coil>

First, individual chips are made by cutting the multilayer body block to a predetermined size using a dicer or the like.

Next, the individual chips are fired. The firing temperature is, for example, higher than or equal to 900° C. and lower than or equal to 920° C. (i.e., from 900° C. to 920° C.). The firing time is, for example, longer than or equal to two hours and shorter than or equal to four hours.

When the individual chips are fired, the green sheets of the coil sheet and the via sheet turn into insulating layers.

Also, when the individual chips are fired, the coil conductor pattern, the via conductor pattern, and the land conductor pattern turn into coil conductors, via conductors, and lands, respectively. As a result, a coil is produced, in which a plurality of coil conductors laminated together with the insulating layers are electrically connected, with the via conductors therebetween. When the cavity-forming resin pattern is burned out, the conductor pattern shrinks more than the green sheet to form cavities.

A multilayer body is thus produced, which is formed by laminating a plurality of insulating layers in the lamination direction and has a coil therein.

The multilayer body may be rounded by barrel finishing or the like at corners and ridges thereof.

### <Step of Forming Outer Electrode>

First, a conductive paste layer is formed by applying a conductive paste, such as a paste containing Ag and fritted glass, to each of the first end surface and the second end surface of the outer surface of the multilayer body to which the coil is extended.

Next, a base electrode for each outer electrode is formed by baking the conductive paste layer. The baking temperature is, for example, higher than or equal to 800° C. and lower than or equal to 820° C. (i.e., from 800° C. to 820° C.). The thickness of the base electrode is, for example, 5 μm.

Then, a Ni-plated electrode and a Sn-plated electrode are formed in sequence on the surface of the base electrode by electrolytic plating or the like. Thus, outer electrodes, each including the base electrode, the Ni-plated electrode, and the Sn-plated electrode in this order, are formed.

A multilayer coil component is thus manufactured.

The following is disclosed in the present specification.

<1> A multilayer coil component includes a multilayer body formed by laminating a plurality of insulating layers, the multilayer body having a coil therein; and a first outer electrode and a second outer electrode electrically connected to the coil. The coil is formed by electrically connecting a plurality of coil conductors laminated together with the insulating layers. The number of the coil conductors is greater than or equal to three. In a cross-section perpendicular to a direction in which the coil conductors extend, a cross-sectional shape of the coil conductors is a flat shape. The coil conductor closest to a center of the multilayer body in a lamination direction is a first coil conductor. A cavity is provided between one surface of at least one of the coil conductors, except the first coil conductor, and the insulating layer. No cavity is provided between an outer end portion of the first coil conductor and the insulating layer.

<2> In the multilayer coil component according to <1>, a cavity is provided between one surface of every coil conductor, except the first coil conductor, and the insulating layer.

<3> In the multilayer coil component according to <1> or <2>, no cavity is provided between the first coil conductor and the insulating layer.

<4> In the multilayer coil component according to <1> or <2>, a cavity is provided between an inner end portion of the first coil conductor and the insulating layer.

<5> In the multilayer coil component according to <1>, the number of the coil conductors is an even number greater than or equal to four. The coil conductor second closest to the center of the multilayer body in the lamination direction after the first coil conductor is a second coil conductor. A cavity is provided between one surface of at least one of the coil conductors, except the first coil conductor and the second coil conductor, and the insulating layer. No cavity is provided between the outer end portion of the first coil conductor and the insulating layer, and between an outer end portion of the second coil conductor and the insulating layer.

<6> In the multilayer coil component according to any one of <1> to <5>, the multilayer body has a first end surface and a second end surface facing each other in a length direction, a first principal surface and a second principal surface facing each other in a height direction orthogonal to the length direction, and a first side surface and a second side surface facing each other in a width direction orthogonal to the length direction and the height direction. A coil axis of the coil is parallel to the first principal surface. The first principal surface is a mounting surface. A space between the coil and the first principal surface in the height direction is greater than or equal to 43 μm.

<7> A multilayer coil component includes a multilayer body formed by laminating a plurality of insulating layers, the multilayer body having a coil therein; and a first outer electrode and a second outer electrode electrically connected to the coil. The coil is formed by electrically connecting a plurality of coil conductors laminated together with the insulating layers. A cavity is provided between at least one of the coil conductors and the insulating layer to be biased toward an inner side of the coil conductor.

<8> In the multilayer coil component according to any one of <1> to <7>, a coil axis of the coil is parallel to a mounting surface.

What is claimed is:

1. A multilayer coil component comprising:
a multilayer body including a plurality of insulating layers that are laminated together, the multilayer body having a coil therein; and
a first outer electrode and a second outer electrode electrically connected to the coil,
wherein the coil is configured by electrically connecting a plurality of coil conductors laminated together with the insulating layers;
a number of the coil conductors is greater than or equal to three;
in a cross-section perpendicular to a direction in which the coil conductors extend, a cross-sectional shape of the coil conductors is a flat shape;
the coil conductor closest to a center of the multilayer body in a lamination direction is a first coil conductor;
a cavity is between one surface of at least one of the coil conductors, except the first coil conductor, and the insulating layer; and
no cavity is between an outer end portion of the first coil conductor and the insulating layer.

2. The multilayer coil component according to claim 1, wherein
a cavity is between one surface of every coil conductor, except the first coil conductor, and the insulating layer.

3. The multilayer coil component according to claim 1, wherein
no cavity is between the first coil conductor and the insulating layer.

4. The multilayer coil component according to claim 1, wherein
a cavity is between an inner end portion of the first coil conductor and the insulating layer.

5. The multilayer coil component according to claim 1, wherein
a number of the coil conductors is an even number greater than or equal to four;
the coil conductor second closest to the center of the multilayer body in the lamination direction after the first coil conductor is a second coil conductor;
a cavity is between one surface of at least one of the coil conductors, except the first coil conductor and the second coil conductor, and the insulating layer; and
no cavity is between the outer end portion of the first coil conductor and the insulating layer, and between an outer end portion of the second coil conductor and the insulating layer.

6. The multilayer coil component according to claim 1, wherein
the multilayer body has a first end surface and a second end surface facing each other in a length direction, a first principal surface and a second principal surface facing each other in a height direction orthogonal to the length direction, and a first side surface and a second side surface facing each other in a width direction orthogonal to the length direction and the height direction;
a coil axis of the coil is parallel to the first principal surface;
the first principal surface is a mounting surface; and
a space between the coil and the first principal surface in the height direction is greater than or equal to 43 μm.

7. The multilayer coil component according to claim 2, wherein
a cavity is between one surface of every coil conductor, except the first coil conductor, and the insulating layer.

8. The multilayer coil component according to claim 2, wherein
no cavity is between the first coil conductor and the insulating layer.

9. The multilayer coil component according to claim 2, wherein
the multilayer body has a first end surface and a second end surface facing each other in a length direction, a first principal surface and a second principal surface facing each other in a height direction orthogonal to the length direction, and a first side surface and a second side surface facing each other in a width direction orthogonal to the length direction and the height direction;
a coil axis of the coil is parallel to the first principal surface;
the first principal surface is a mounting surface; and
a space between the coil and the first principal surface in the height direction is greater than or equal to 43 μm.

10. The multilayer coil component according to claim 5, wherein
the multilayer body has a first end surface and a second end surface facing each other in a length direction, a first principal surface and a second principal surface facing each other in a height direction orthogonal to the length direction, and a first side surface and a second side surface facing each other in a width direction orthogonal to the length direction and the height direction;
a coil axis of the coil is parallel to the first principal surface;
the first principal surface is a mounting surface; and
a space between the coil and the first principal surface in the height direction is greater than or equal to 43 μm.

11. The multilayer coil component according to claim 1, wherein
a coil axis of the coil is parallel to a mounting surface.

12. A multilayer coil component comprising:
a multilayer body including a plurality of insulating layers that are laminated together, the multilayer body having a coil therein; and
a first outer electrode and a second outer electrode electrically connected to the coil,
wherein the coil is configured by electrically connecting a plurality of coil conductors laminated together with the insulating layers; and
a cavity is between at least one of the coil conductors and the insulating layer to be biased toward an inner side of the coil conductor.

13. The multilayer coil component according to claim 12, wherein
a coil axis of the coil is parallel to a mounting surface.
